(19) United States
(12) Patent Application Publication
(10) Pub. No.: US 2003/0018471 A1
(43) Pub. Date: Jan. 23, 2003

(54) MEL-FREQUENCY DOMAIN BASED AUDIBLE NOISE FILTER AND METHOD

(76) Inventors: YAN MING CHENG, SCHAUMBURG, IL (US); ANSHU AGARWAL, SAN JOSE, CA (US)

Correspondence Address: JONATHAN P MEYER, MOTOROLA INC, 1303 EAST ALGONQUIN ROAD, SCHAUMBURG, IL, 60196

(21) Appl. No.: 09/427,497

(22) Filed: Oct. 26, 1999

(51) Int. Cl. G10L 15/20; G10L 21/00

(52) U.S. Cl. 704/233; 704/275

(57) ABSTRACT

An audio filter consists of two substantially identical stages with different purposes. The first stage (301) whitens detected noise, while preserving speech or other audible information in an undistorted manner. The second stage (303) effectively eliminates the residual white noise. Each stage, in one embodiment, includes a Mel domain based error minimization stage (108). A two stage Mel-frequency domain Wiener filter (300) is designed for each speech time frame in the Mel-frequency domain, instead of linear frequency domain. Each Mel domain based error minimization stage (108) minimizes the perceptual distortion and reduces the computation requirement to provide suitably filtered audible information.

### FIELD OF THE INVENTION

The invention relates generally to audio filters, and more particularly to filters and methods for filtering noise from a noisy audible signal.

### BACKGROUND OF THE INVENTION

Speech recognition systems, and other systems that attempt to detect desired audible information from a noisy audible signal, typically require some type of noise filtering. For example, speech recognizers used in wireless environments, such as in automobiles, may encounter extremely noisy interference problems due to numerous factors, such as the playing of a radio, engine noise, traffic noise outside of the vehicle and other noise sources. A problem can arise since the performance of speech recognizers may degrade dramatically in automotive conditions. The noise from the automobile or other sources is additive. This noise is then added to, for example, a voice signal that is used for communicating with a device that is attempting to recognize audible commands or other audible input.

One known technique to provide noise reduction, for example, for speech enhancement, attempts to clean up the noise and recover speech by filtering out the noise prior to attempting voice recognition. Other techniques include learning the speech signal during noisy conditions and training a speech recognizer to detect the differences between the desired audible information and the noisy information. However, it is often difficult to produce all noises in all frequencies that may be encountered, particularly in a dynamic noise environment, such as an automobile environment.

Spectral subtraction, as known in the art, is a noise reduction technique which attempts to subtract the noisy spectrum from noisy speech spectrum by sampling when speech is being generated as compared with periods of silence, when only noise is present. Hence, a window of sampled noise is taken when speech is not being detected and the sampled noise is then inverted to cancel out the noise components from a noisy audible input signal. These systems typically operate in a linear frequency domain and can be costly to implement. In addition, this technique is based on direct estimation of short term spectral magnitudes. With this approach, speech is modeled as a random process to which uncorrelated random noise is added. It is assumed that noise is short term and stationary. The noise power spectrum is subtracted from a transformed input signal. Short term Wiener filtering is another approach in frequency weighting where an optimum filter is first estimated from the noisy speech. A linear estimator of uncorrupted speech minimizes the mean square error, which is obtained by filtering the input signal with a non-causal Wiener filter. This Wiener filter or error minimization stage, requires apriori knowledge of speech and noise statistics and therefore it must also adapt to changing characteristics.

However, noise typically changes as the speech recognition system or other audible input device moves into other environments. Again, if the noise is sampled during non-speech periods, the sampled noise becomes a rough estimation of the actual noise. However, the actual noise varies with the environment, which can make conventional Wiener filters ineffective. In addition, Wiener filters are typically designed to filter out noise in the linear frequency domain which can require large processing overhead for digital signal processors and other processors performing dynamic noise reduction. Furthermore, the linear Wiener filter is typically not effective to reduce “audible” noise. Instead it is effective to reduce physical noise.

In addition, it is known for speech recognizers to receive a speech signal that has already been filtered for noise and to subsequently perform Mel conversion, sometimes referred to as Mel-warping on the filtered speech signal. The filtered speech signal is transformed from a linear frequency spectrum into the Mel-spectrum through a Mel converter, such as by using a Mel Discrete Cosine Transform (Mel-DCT). However, Mel conversion is typically performed on speech or other audible information that is noise free. Generally, the noise filtering techniques may be of the type of spectral subtraction or other type that typically performs filtering using a linear frequency domain filtering process. This can result in the unnecessary use of processing overhead. In addition, many noise reduction techniques cannot dynamically adapt to changes in the environment that modify the noise components of the noisy audible signal. Although there are many techniques used to separate speech from noise, many of these techniques may not be effective. For example, spectral subtraction may not be effective in very low signal-to-noise ratio conditions due to a difficulty in accurately predicting the noise spectrum. Conventional Wiener filters are effective in removing white noise, but typically not automobile noise or other noise which is mostly colored.

Accordingly, there exists a need for an audio signal filter and method that reduces noise to enhance speech, or other audible information, to improve speech recognition performance or other audible information detection in noisy environments, such as wireless communication environments, or other desired environments.

### BRIEF DESCRIPTION OF THE DRAWINGS

FIG. 1 is a block diagram illustrating one example of an audio filter in accordance with one embodiment of the invention;

FIG. 2 is a flow chart illustrating one example of the operation of the audio filter shown in FIG. 1; and

FIG. 3 is a block diagram illustrating one example of a two stage audio filter in accordance with one embodiment of the invention.

### DETAILED DESCRIPTION OF THE PREFERRED EMBODIMENT

Generally, an audio filter and method performs noise suppression in a perceptually relevant Mel-frequency domain and removes complex noise interference using one or two stages. A first stage whitens detected noise while preserving speech. A second stage, if used, removes the whitened noise. Accordingly, the audio filter and method reduces a noisy portion of a noisy audible signal resulting in residual noise and converts the residual noise to a white noise signal while preserving desired audible information. The white noise signal is subsequently filtered from the desired audible information.

In one embodiment, the audio filter consists of two substantially identical stages with different purposes. The first stage whitens detected noise, while preserving speech or other audible information in an undistorted manner. The second stage effectively eliminates the residual white noise. Each audio noise filter stage, in one embodiment, includes a Mel domain based error minimization stage which may include, for example, a Mel-frequency domain Wiener filter that is designed for each speech time frame in the Mel-frequency domain. Each Mel-based error minimization stage minimizes the perceptual distortion and drastically reduces the computation requirement to provide suitably filtered audible information.

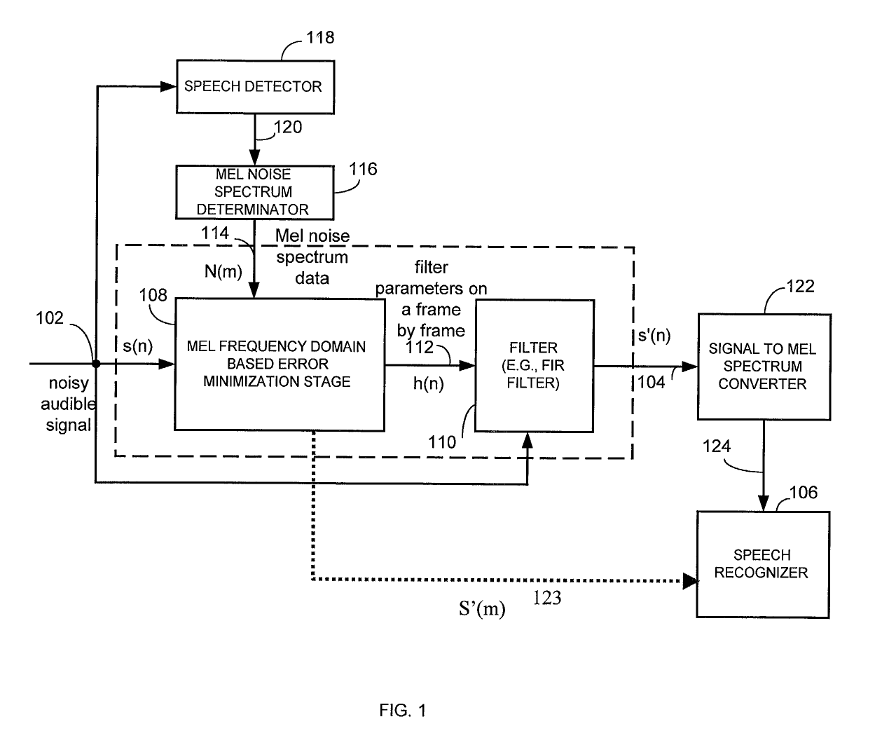

FIG. 1 illustrates one example of an audio filter 100 that filters a noisy audible signal 102 (s(n)) and outputs desired audible information, such as Mel-frequency based filtered noisy audio signal 104 (s′(n)), such as filtered speech information, to a speech recognizer 106 or any other suitable device or process that uses the filtered audible information. For purposes of illustration, and not limitation, the disclosed audio filters and methods will be described with reference to filtering speech information in a wireless speech recognition system having the speech recognizer 106. However, it will be recognized that the disclosed audio filters and methods described herein, may be used in any suitable apparatus or system requiring audio noise filtering. The noise on the noisy audible signal 102 may change, for example, on a frame by frame basis in highly noisy and dynamic environments, such as in automobiles or other suitable environments. Hence, the audio filter 100 includes a Mel-frequency domain based error minimization stage 108, and a filter 110, such as a finite impulse response filter (FIR), or any other suitable filter that adjusts and filters noise preferably on a frame by frame basis. However, non-frame based intervals of noisy audible signal may also be used.

The Mel-frequency domain based error minimization stage 108 reduces a noisy portion of the noisy audible signal 102 resulting in some residual noise. The Mel-frequency domain based error minimization stage 108 also converts the residual noise to a white noise signal, based on a sampled noise signal 120, while preserving desired audible information. The error minimization performed by the Mel-frequency domain based error minimization stage 108 performs error minimization based on the following formulas:

Ŝ(m)=\sqrt{R(m)−N(m)}

S′(m)=H(m)·S(m)

is an enhanced Mel-spectrum signal, S′(m) is a Mel domain converted output signal from

where Ŝ(m)

a first stage Mel Wiener filter stage, H(m) is the Mel domain transfer function of the Wiener filter, S(m) is Mel-frequency converted signal, R(m) is noisy speech information (power spectrum) referred to as Mel-frequency domain information, derived from a Mel DCT transformation; and N(m) is sampled noise converted to the Mel-frequency domain, namely Mel noise spectrum data.

The error in the Mel-frequency domain E(m) is represented as:

E(m)=∫ₘ(Ŝ(m)−S′(m))²dm

The Mel-frequency based error minimization stage 108 chooses H(m) so that E(m) is minimized, wherein H(m) is defined as:

$$H ( m ) = \frac{R ( m ) - N ( m )}{R ( m )}$$

The Mel-frequency domain based error minimization stage 108 provides filter parameters 112, preferably on a frame by frame basis, for the filter 110, which is operatively coupled to subsequently filter generated white noise signal from the desired audible information. The filter 110 performs, for example, conventional convolution in the time domain. However, the Mel-frequency domain based error minimization stage 108 attempts to minimize error caused by noise in the Mel-frequency domain.

The Mel-frequency domain based error minimization stage 108, preferably includes a Mel-warped Wiener filter. The Mel-frequency domain based error minimization stage 108 is operatively responsive to Mel noise spectrum data 114 N(m) which is obtained from a suitable source. In this embodiment, the Mel noise spectrum data 114 is generated by a Mel noise spectrum determinator 116. The Mel noise spectrum data 114 is the average of non-speech frames from the beginning of the signal up to the current frame. If desired, an audible information detector, such as a speech detector 118, may also be used to detect when speech occurs during sampling periods. The speech detector 118 outputs the sampled noise signal 120, for example, when no speech is detected so that the Mel noise spectrum determinator 116 can sample only noise between speech frames or other suitable intervals. The Mel noise spectrum determinator 116 therefore has an input for receiving sampled noise, and an output that provides the Mel noise spectrum data 114 for the Mel-frequency domain based error minimization stage 108. The Mel noise spectrum determinator 116 effectively converts the sampled noise signal 120 from a linear frequency domain, to a Mel-frequency domain for use by the Mel-frequency domain based error minimization stage 108.

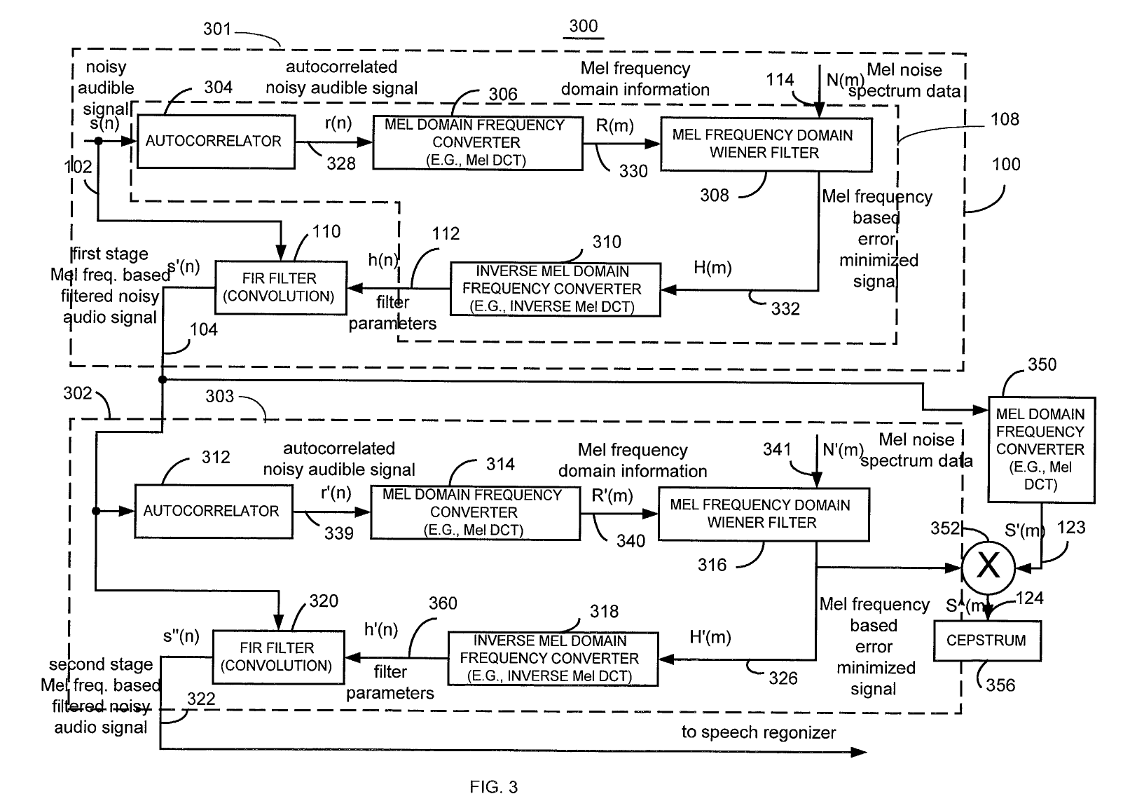

The audio filter 100, in this embodiment, is shown as being a single stage audio filter. However, as further described with reference to FIG. 3, a multi-stage filter may provide additional advantages.

The filter 110 also receives the noisy audible signal 102 and the filter parameters 112 to provide the desired audible information, such as Mel-frequency based filtered noisy audio signal 104 for speech recognizer 106 or other suitable device or process. The Mel-frequency based filtered noisy audio signal 104, which is in a linear time domain, is converted to the Mel-frequency domain using a Mel-frequency domain converter 122, such as a Mel Discrete-Cosine Transform (Mel-DCT), as known in the art. This results in an enhanced Mel-spectrum of speech signal 124. The filter 110 has an output operatively coupled, for example, to the speech recognizer 106 to provide the desired audible information, Mel-frequency based filtered noisy audio signal 104, for the speech recognizer stage.

The Mel-frequency domain based error minimization stage 108 includes a Mel-frequency domain Wiener filter that whitens the noise while preserving the speech. The second stage, such as that shown in FIG. 3, removes the remaining white noise. A Mel domain based error minimization stage 108 provides error minimization in a Mel-frequency scale to sufficiently scale or reduce noise for perceptual frequencies which results in lower computation requirements and also provides Mel-frequency domain information 123 that is matched with standard Mel cepstrum front end and automatic speech recognizers. Accordingly, Mel-frequency domain information (S′(m)) 123 from the Mel domain based error minimization stage 108 may be provided directly for the speech recognizer. Hence, the same Mel domain information can also be used for the speech recognizer 106.

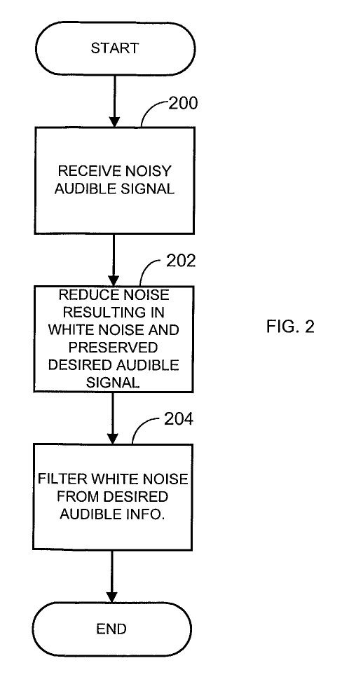

FIG. 2 illustrates a flow chart showing the operation of audio filter 100. As shown in block 200, the audio filter 100 receives a noisy audible signal 102. The audio filter 100 reduces a noisy portion of the noisy audible signal 102, resulting in residual noise and converts the residual noise to a white noise signal while preserving desired audible information, using, for example, a Mel domain based Wiener filter that uses the Mel noise spectrum data 114 as input. This is shown in block 202. As shown in block 204, the method includes subsequently filtering the white noise signal from the desired audible information to obtain a filtered desired audible signal. This is preferably performed on a speech frame by speech frame basis. The process then continues for each speech frame or group of speech frames, as desired.

FIG. 3 illustrates another embodiment of the invention showing a two stage audible noise filter 300. A first stage 301 includes the audio filter 100 and a second stage 303 includes filter 302. The two stage audible noise filter 300 includes essentially two identical stages that are used for different purposes. The first stage 301 is aimed to whiten noise while preserving speech or other audible information, in an undistorted manner. The second stage 303 is used to substantially eliminate the residual white noise left over from the first stage 301. Each stage 301 and 303 uses a Mel-frequency domain based error minimization stage 108 in the form of a Mel-frequency domain Wiener filter having an adaptive Wiener filter design. As such, the adaptive Wiener filter estimates filter parameters on a frame-by-frame basis according to the noise spectrum and noisy speech spectrum at each frame. The Mel-frequency domain based error minimization stages are designed to minimize error due to noise for each speech time frame in the Mel-frequency domain instead of in a linear frequency domain for which conventional Wiener filters have been designed.

As shown, the audio filter 100 includes an autocorrelator 304, a Mel-frequency domain converter 306, a Mel-frequency domain Wiener filter 308, an inverse Mel-frequency domain converter 310, and the filter 110.

Similarly, filter 302 includes an autocorrelator 312, a Mel-frequency domain converter 314, a Mel-frequency domain Wiener filter 316, an inverse Mel-frequency domain converter 318 and a filter 320. In addition, if it is desired to share Mel converted data with a speech recognition front end, the two stage audible noise filter 300 may also include a Mel-frequency domain converter 350, a signal converter 352, and a Cepstrum 356. This can allow sharing of similar operations and avoid duplication of some computations

The autocorrelator 304 has an input operatively coupled to receive the noisy audible signal 102 and has an output operatively coupled to provide an autocorrelated noisy audible signal 328 (r(n)), such as a set of autocorrelation coefficients, for the Mel-frequency domain converter 306. As known in the art, an autocorrelator converts a series of digitized noisy speech signals (s(n)), such as 256 points, to a set of autocorrelation coefficients, such as 32 points. The Mel-frequency domain converter 306 receives the autocorrelated noisy audible signal 328 (autocorrelation coefficients) and generates Mel-frequency domain information 330 (R(m)). In this example, the Mel-frequency domain converter 306 is a Mel-frequency domain based discrete cosine transform (Mel DCT) operation that converts the 32 autocorrelation coefficients to 32 points in a power-spectrum in Mel-frequency represented as (R(m)), wherein:

$$R ( m ) = \frac{1}{2} {\sum }_{n = - N + 1}^{N - 1} r ( n ) {ⅇ}^{- j f ( m ) n} where$$

$$f ( m ) = 2 π \frac{C}{{f}_{s}} ( {ⅇ}^{m / K} - 1 )$$

Where K is a constant, m is the Mel scale and fs is the sampling frequency.

The Mel-frequency domain Wiener filter 308 takes the power spectrum information, namely, the Mel-frequency domain information 330 and an estimate of the noise power spectrum at a current frame, namely the Mel noise spectrum data 114, to dynamically provide a Mel-frequency Wiener filter based on an approach described, for example, by J. R. Deller, Jr., J. G. Proakis and J. H. Hansen, in “Discrete-Time processing of Speech Signals” (Macmillan Publishing Company, New York, 1993, pp. 517-528, incorporated herein by reference, according to the following formula:

$$H ( m ) = \frac{R ( m ) - N ( m )}{R ( m )}$$

The Mel-frequency domain Wiener filter 308 provides Mel-frequency domain based error minimization on a noisy audible signal using the Mel-frequency domain information 330 to generate the filter parameters 112. The Mel-frequency domain Wiener filter 308 obtains the Mel noise spectrum data 114 from the Mel noise spectrum determinator 116, or any other suitable source. A Mel-frequency domain based output signal 332 (H(m)) from the Mel-frequency domain Wiener filter 308 is a signal that has gone through error minimization by converting the noise to white noise while leaving the speech information substantially intact. The output signal 332 from the Mel-frequency Wiener filter domain is then converted to the filter parameters 112 (h(n)) such as finite impulse response coefficients, through the inverse Mel-frequency domain converter 310. The inverse Mel-frequency domain converter 310 is operatively coupled to convert the output signal 332, from the Mel-frequency domain to the linear frequency domain filter parameters 112. The inverse Mel-frequency domain converter may be, for example, an inverse Mel Discrete-Cosine Transform that converts the output signal 332 to a time series of non-causal finite impulse response coefficients. This may be performed, for example, such that:

$$h ( n ) = \frac{1}{2} {\sum }_{j = 0}^{M} H ( f ( {m}_{j} ) ) cos ( f ( {m}_{j} ) n ) 2 π \frac{C}{{Kf}_{s}} {ⅇ}^{{m}_{j} / K} Δ m$$

Where mj is a set of discrete sample points in the Mel domain, Δm is the sampling eriod and M is number of points, (e.g., 32) that the Wiener filter has in the Mel-frequency domain.

A Hamming window of the size of 64, for example, and centered at n=0 is applied at the output. The filter 110, such as a finite impulse response filter, performs a convolution between the noisy audible signal 102 and the non-causal finite impulse response coefficients, i.e., filter parameters 112 (h(n)) to produce the first stage enhanced speech signal, namely, the first stage Mel-frequency based filtered noisy audio signal 104. Hence, the filter parameters 112 are generated based on performing Mel-frequency domain based error minimization through the Mel-frequency domain Wiener filter 308 using the Mel noise spectrum data 114 and the Mel-frequency domain information 330. The Mel-frequency domain based error minimization stage 108 generates the filter parameters 112 on a dynamic frame by frame basis to accommodate dynamic changes in noise. Similarly, filter parameters 360 in the second stage of filter 302 are also generated dynamically on a frame by frame basis.

For the second stage 303, the filter 302, the operation of the autocorrelator 312, Mel-frequency domain converter 314, Mel-frequency domain Wiener filter 316, inverse Mel-frequency domain converter 318 and filter 320, are the same as those described with reference to audio filter 100. However, the input signal to the second stage 303 is the output from the first stage, namely, the first stage Mel-frequency based filter noisy audio signal 104. The output of the second stage is a second stage Mel-frequency based filtered noisy audio signal (s″(n)) 322.

The filter 302 therefore includes another Mel domain frequency converter 314 that converts the first stage Mel-frequency based filtered noisy audio signal 104 to Mel-frequency domain information 340 (R′(m)). The autocorrelator 312 provides the autocorrelation coefficients 339 (r′(n)) that are generated based on the first stage Mel-frequency based filtered noisy audio signal 104.

The Mel-frequency domain Wiener filter 316 provides Mel-frequency domain based error minimization on the first stage Mel-frequency based filtered noisy audio signal 104 using the Mel-frequency domain information 340 to generate filter parameters 360 (h′(n)), based on performing Mel-frequency domain based error minimization using the Mel noise spectrum data 341 (N′(m) and the Mel-frequency domain information 340 (R′(m)). The Mel noise spectrum data 341 (N′(m)) is derived from the output of the first stage 301, namely the Mel-frequency based filtered noisy audio signal 104, using the speech detector 118 and the Mel noise spectrum determinator 116 to detect period of noise in the same way that the Mel noise spectrum data 114 is derived for the first stage 301. The second stage Wiener filter output signal 326 (H′(m)) is passed through an inverse Mel-frequency domain converter 318 to provide the filter parameters 360 to filter 320. The filter 320, generates the second stage Mel-frequency based filtered noisy audio signal 322 based on the filter parameters 360 and the first stage Mel-frequency based filtered noisy audio signal 104. As described, the first stage attempts to whiten colored noise while preserving the speech, and the second stage removes remaining white noise that has not been removed in the first stage. Hence, the first stage Mel-frequency domain filter noisy audio signal 104 may contain residual noise, which is then removed by the second stage. Due to the predictive nature of the noise estimation from the first stage, there may be noise error minimization overcompensation or undercompensation. With the second stage, the white noise is removed not only by estimated compensation but also due to the uncorrelated nature of white noise.

For the sole purpose of speech enhancement, blocks 350, 352 and 356 may not be used to provide Mel domain information to a speech enhancement stage. However, for the purpose of creating a noise robust front end for a speech recognizer, the second stage filtering is performed in the Mel-frequency domain. The Mel-frequency domain converter 350 performs a Mel DCT operation to generate a converted signal, such as the Mel-frequency domain information 123 (S′(m)). The combiner 352 multiplies the converted signal, namely the Mel-frequency domain information 123 and second stage Wiener filter output signal 326 to directly obtain the enhanced Mel-spectrum of speech signal 124 (Sˆ (m)) in the Mel-frequency domain. Block 356 performs the conventional Cepstrum analysis to generate the standard front-end coefficients for speech recognition.

In sum, the two stage audible noise filter 300 computes autocorrelation lags for an incoming speech frame, for example, 20 lags, the resulting speech frame is represented as r(n). The filter computes the Discrete-Cosine Transform on a Mel-frequency scale and takes M equally spaced frequencies on a Mel scale resulting in signal R(m), for example, where M=32. The two stage audible noise filter 300 dynamically determines a suitable Mel-frequency domain Wiener filter using Wiener filter design criteria and provides error minimization using the Mel-frequency domain Wiener filter. An inverse Mel-frequency domain converter then computes the inverse Mel DCT of the resulting output signal 332. The filter then convolves noisy audible signal 102, such as the current speech frame, with the h(n) filter coefficients to obtain the enhanced signal, namely, the Mel-frequency based filtered noisy audio signal 104. These steps are repeated for the second stage. The second stage output from the Mel-frequency domain filter may be multiplied with the Mel DCT transformation of the first stage signal. This gives the power spectrum of enhanced signal in a Mel-frequency scale.

The above described filters may be implemented using software or firmware executed by a processing device, such as a digital signal processor (one or more), microprocessors, or any other suitable processor, and/or may be implemented in hardware including, but not limited to, state machines, discrete logic devices, or any suitable combination thereof. It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for filtering an audible signal comprising the steps of:
(a) receiving a noisy audible signal;
(b) reducing a noisy portion of the noisy audible signal resulting in residual noise and converting the residual noise to a white noise signal while preserving desired audible information; and
(c) subsequently filtering the white noise signal from the desired audible information.

2. The method of claim 1 wherein step (b) includes the steps of:
autocorrelating the noisy audible signal to produce an autocorrelated noisy audible signal; and
converting the autocorrelated noisy audible signal to Mel-frequency domain information (R(m)).

3. The method of claim 2 including the step of providing Mel-frequency domain based error minimization on the noisy audible signal using the Mel-frequency domain information to generate filter parameters (h(n)).

4. The method of claim 3 wherein the step of providing Mel-frequency domain based error minimization on the noisy audible signal includes using a Mel-frequency domain Wiener filter.

5, The method of claim 1 including a step (d) of subsequently providing the desired audible information for a speech recognition process.

6. The method of claim 3 wherein the filter parameters are generated on a dynamic frame by frame basis.

7. A method for filtering an audible signal comprising the steps of:
(a) receiving a noisy audible signal;
(b) obtaining Mel noise spectrum data (N(m)) based on the noisy audible signal;
(c) converting the noisy audio signal to first Mel-frequency domain information (R(m));
(d) generating first filter parameters based on performing Mel-frequency domain based error minimization using the Mel noise spectrum data (N(m)) and the first Mel-frequency domain information (R(m)); and
(e) filtering the noisy audio signal based on the generated first filter parameters to generate a first stage Mel-frequency based filtered noisy audio signal (s′(n)).

8. The method of claim 7 including the steps of:
receiving the first stage Mel-frequency based filtered noisy audio signal;
obtaining Mel noise spectrum data (N′(m)) based on the first stage Mel-frequency based filtered noisy audio signal converting the first stage Mel-frequency based filtered noisy audio signal to second Mel-frequency domain information;
generating second filter parameters based on performing Mel-frequency domain based error minimization using the Mel noise spectrum data (N′(m)) and the second Mel-frequency domain information (R′(m));and
filtering the first stage Mel-frequency based filtered noisy audio signal based on the generated second filter parameters to generate a second stage Mel-frequency based filtered noisy audio signal (s″(n)).

9. The method of claim 7 wherein the step of generating the first filter parameters includes using a Mel-frequency domain Wiener filter.

10. The method of claim 8 including the step of subsequently providing the second stage Mel-frequency based filtered noisy audio signal as desired audible information for a speech recognition process.

11. The method of claim 7 wherein the first filter parameters are generated on a dynamic frame by frame basis.

12. The method of claim 8 wherein the second filter parameters are generated on a dynamic frame by frame basis.

13. An audio filter comprising:
at least one Mel-frequency domain based error minimization stage, operatively coupled to receive a noisy audible signal, and operatively responsive to Mel noise spectrum data, that reduces a noisy portion of the noisy audible signal resulting in residual noise and converting the residual noise to a white noise signal while preserving desired audible information; and
at least one finite impulse response filter operatively coupled to subsequently filter the white noise signal from the desired audible information.

14. The audio filter of claim 13 wherein the Mel-frequency domain based error minimization stage includes:
an autocorrelator having an input operatively coupled to receive the noisy audible signal and an output operatively coupled to provide an autocorrelated noisy audible signal produced by the autocorrelator; and
a Mel-frequency domain converter operatively responsive to the autocorrelated noisy audible signal that generates Mel-frequency domain information from the autocorrelated noisy audible signal.

15. The audio filter of claim 14 including a Mel-frequency domain Wiener filter operatively responsive to the Mel-frequency domain information, to provide Mel-frequency domain based error minimization on the noisy audible signal using the Mel-frequency domain information to generate filter parameters (h(n)).

16. The audio filter of claim 13 having an output operatively coupled to provide the desired audible information for a speech recognizer stage.

17. The audio filter of claim 15 including an inverse Mel-frequency domain converter operatively coupled to convert the filter parameters from the Mel-frequency domain Wiener filter into frequency domain filter parameters.

18. The audio filter of claim 15 wherein the at least one Mel-frequency domain based error minimization stage generates the filter parameters on a dynamic frame by frame basis.

19. The audio filter of claim 14 including at least one Mel noise spectrum determinator, having an input for receiving noise and an output that provides the Mel noise spectrum data for the at least one Mel-frequency domain based error minimization stage.

20. An audio filter comprising:
a first stage operatively coupled to receive a noisy audible signal wherein the first stage includes:
at least one Mel noise spectrum determinator having an output that provides Mel noise spectrum data based on the noisy audible signal;
at least a first Mel-frequency domain converter operatively responsive to the noisy audible signal that generates first Mel-frequency domain information for a given frame of noisy audible signal;
a first Mel-frequency domain Wiener filter operatively responsive to the first Mel-frequency domain information, to provide Mel-frequency domain based error minimization on the noisy audible signal using the Mel-frequency domain information to generate first filter parameters wherein the Mel-frequency domain Wiener filter generates the first filter parameters based on performing Mel-frequency domain based error minimization using the Mel noise spectrum data (N(m)) and the first Mel-frequency domain information (R(m)); and
at least a first finite impulse response filter operatively coupled to filter the noisy audio signal based on the generated first filter parameters to generate a first stage Mel-frequency based filtered noisy audio signal (s′(n)).

21. The audio filter of claim 20 including a second stage, operatively coupled to receive the first stage Mel-frequency based filtered noisy audio signal, that includes:
at least a second Mel domain frequency converter operatively coupled to convert the first stage Mel-frequency based filtered noisy audio signal to second Mel-frequency domain information;
a second Mel-frequency domain Wiener filter operatively responsive to the second Mel-frequency domain information, to provide Mel-frequency domain based error minimization on the first stage Mel-frequency based filtered noisy audio signal using the second Mel-frequency domain information to generate second filter parameters wherein the second Mel-frequency domain Wiener filter generates the second filter parameters based on performing Mel-frequency domain based error minimization using the first stage Mel-frequency based filtered noisy audio signal and the second Mel-frequency domain information (R′(m)); and
at least a second finite impulse response filter operatively coupled to filter first stage Mel-frequency based filtered noisy audio signal based on the generated second filter parameters to generate a second stage Mel-frequency based filtered noisy audio signal (s″(n)).

22. The audio filter of claim 21 wherein the second stage is operatively coupled to provide the second stage Mel-frequency based filtered noisy audio signal as desired audible information for a speech recognition process.

23. The audio filter of claim 21 wherein the first filter parameters are generated on a dynamic frame by frame basis.

24. The audio filter of claim 21 wherein the second filter parameters are generated on a dynamic frame by frame basis.
